(19) United States
(12) Patent Application Publication
(10) Pub. No.: US 2025/0277665 A1
(43) Pub. Date: Sep. 4, 2025

(54) CAMERA-RADAR SPATIO-SPECTRAL BEV QUERY TO IMPROVE BEV TRANSFORMERS FOR 3D PERCEPTION TASKS

(71) Applicant: QUALCOMM Technologies, Inc., San Diego, CA (US)

(72) Inventors: Jonas Schramm, Oberursel (DE); Niclas Vödisch, Paris (FR); Kürsat Petek, Freiburg (DE); Abhinav Valada, Freiburg (DE); Kiran Bangalore Ravi, Paris (FR); Senthil Kumar Yogamani, San Diego, CA (US)

(21) Appl. No.: 19/066,342

(22) Filed: Feb. 28, 2025

Related U.S. Application Data
(60) Provisional application No. 63/559,697, filed on Feb. 29, 2024.

(51) Int. Cl. G01C 21/34; G01S 13/86; G01S 13/89; G06T 9/00; G06V 10/44

(52) U.S. Cl. CPC G01C 21/34; G01S 13/867; G01S 13/89; G06T 9/00; G06V 10/44

(57) ABSTRACT

Systems, methods, and computer-readable media are described. An example system for processing data includes one or more memories that store radar data from a radar system. The radar data includes frequency domain data. The one or more memories also store image data from a plurality of camera sensors. The system includes one or more processors configured to encode the image data to generate encoded image data. The one or more processors are configured to encode the frequency domain data using an encoder to generate encoded radar data. The one or more processors are configured to fuse the encoded radar data and the encoded image data to generate fused data. The one or more processors are configured to navigate a vehicle based on the fused data.

This application claims the benefit of U.S. Provisional Patent Application No. 63/559,697, filed Feb. 29, 2024, the entire content of which is incorporated by reference.

### TECHNICAL FIELD

This disclosure relates to computer vision and perception systems.

### BACKGROUND

An autonomous driving vehicle is a vehicle that is configured to sense the environment around the vehicle, such as the existence and location of other objects, and operating without or limited human control. An autonomous driving vehicle may include a radar system, a camera system, and/or other sensor system for sensing data indicative of the existence and location of other objects around the autonomous driving vehicle. In some examples, such an autonomous driving vehicle may be referred to as an ego vehicle. A vehicle having an advanced driver-assistance systems (ADAS) is a vehicle that includes systems which may assist a driver in operating the vehicle, such as parking or driving the vehicle.

Some autonomous driving vehicles may include a bird's-eye-view (BEV) representation of sensor data which may be displayed or otherwise used in navigating the vehicle. A BEV representation of objects in the vicinity of an autonomous driving vehicle may include an overhead representation of such objects.

### SUMMARY

The present disclosure generally relates to techniques and devices for fusing multi-camera and radar data of a device (e.g., vehicle, robot, virtual reality (VR) device, etc.) to improve object segmentation as well as semantic map segmentation in a bird's-eye-view (BEV) representation. Such techniques may be applicable to current production vehicles having radar and multi-camera systems and may improve the accuracy of localization of 3D object detection, BEV segmentation, and BEV instance segmentation tasks by fusing camera and radar range-Doppler features. By improving the accuracy of localization of 3D object detection, BEV segmentation, and BEV instance segmentation tasks, the techniques of this disclosure may provide a more accurate determination of free space for navigation about the device, leading to greater navigation safety.

While the techniques of this disclosure are primarily discussed with respect to a vehicle, it should be understood that these techniques are applicable for use with other devices, such as robots, VR devices, or other devices where more accurate perception of space and things within the space may be desirable.

In one example, a system includes: one or more memories for storing radar data from a radar system, the radar data comprising frequency domain data, and image data from a plurality of camera sensors; and one or more processors in communication with the one or more memories, the one or more processors configured to: encode the image data to generate encoded image data; encode the frequency domain data using an encoder to generate encoded radar data; fuse the encoded radar data and the encoded image data to generate fused data; and navigate a vehicle based on the fused data.

In another example, a method includes: encoding image data from a plurality of camera sensors to generate encoded image data; encoding frequency domain data of radar data from a radar system using an encoder to generate encoded radar data; fusing the encoded radar data and the encoded image data to generate fused data; and navigating a vehicle based on the fused data.

In another example, computer-readable media stores instructions which, when executed by one or more processors, cause one or more processors to: encode image data from a plurality of camera sensors to generate encoded image data; encode frequency domain data of radar data from a radar system using an encoder to generate encoded radar data; fuse the encoded radar data and the encoded image data to generate fused data; and navigate a vehicle based on the fused data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system according to one or more aspects of this disclosure.

FIG. 2 is a block diagram illustrating an example BEV fusion architecture.

FIG. 3 is a block diagram illustrating a baseline example BEV fusion architecture.

FIG. 4 is a block diagram illustrating an example baseline radar point cloud to BEV feature encoder.

FIG. 5 is a block diagram illustrating an example BEV fusion architecture according to one or more aspects of this disclosure.

FIG. 6 is a conceptual diagram illustrating example query initialization techniques according to one or more aspects of this disclosure.

FIG. 7 is a conceptual diagram illustrating example query attention techniques according to one or more aspects of this disclosure.

FIG. 8 is a block diagram illustrating an example architecture of one single fusion transformer block according to one or more aspects of this disclosure.

FIG. 9 is a flow diagram illustrating example camera-radar spatio-spectral BEV query techniques according to one or more aspects of this disclosure.

### DETAILED DESCRIPTION

Multiple sensor systems, such as camera, radar, and/or Light Detection and Ranging (LiDAR) systems, may be used together in various different robotic, vehicular, and virtual reality (VR) applications. One such vehicular application is an advanced driver assistance system (ADAS). ADAS is a system that utilizes multiple sensor systems, such as camera, radar, and/or LiDAR sensor systems, to improve driving safety, comfort, and overall vehicle performance. Such a system combines the strengths of various sensors to provide a more comprehensive view of a vehicle's surroundings, enabling the ADAS to better assist the driver in various driving scenarios.

Camera sensors and radar sensors are lower cost perception sensors which are typically found in modern series production vehicles, while LiDAR sensors are not typically found in modern series production vehicles. As such, implementation of autonomous driving solutions requiring LiDAR may be unimplementable for modern series production vehicles.

Camera sensors typically have a relatively high angular resolution, while radar sensors can be used to provide good depth and direct velocity measurements. Given multi-camera system images, and radar point clouds, there are multiple papers that describe transformer-based architectures to improve 3D object detection. Example operations include multi-camera features generation, perspective to BEV lifting, and camera-radar BEV feature fusions.

There are papers that describe using the power spectrum or frequency domain output from radar systems directly as input to a deep neural network and outputting a 3D detection. The advantage of such techniques include not needing custom fixed digital signal processor (DSP) (e.g., signal processing inverse fast Fourier transform (IFFT)) blocks that are difficult to tune to improve detection or segmentation accuracy in a 3D perception stack. Specific architectures have been described to ingest aggregated views of a range-angle-Doppler (RAD) tensor to detect objects in the range-angle (RA) view. The entire tensor has also been considered, either for object detection in both RA and range-Doppler (RD) views, or for object localization in the camera image. A MIMO encoder along with range-angle decoder may be used to obtain spatial domain representation for radar point clouds directly using complex Doppler spectrums. Such an architecture leverages complex range-Doppler spectrums containing all the range, azimuth, and elevation information. This data is de-interleaved and compressed by a MIMO pre-encoder. A feature pyramid network (FPN) encoder extracts a pyramid of features which the range-angle decoder converts into a latent range-azimuth representation. Based on this representation, multi-task heads finally detect vehicles and predict the free driving space.

Radar point clouds are sparse and generally have poor spatial representation, while a rich dense representation in the fast Fourier transform (FFT) domain using the range-doppler spectrums. There are multiple transformer-based query techniques today for camera-based BEV features fusion for 3DOD or segmentation using radar point clouds in a spatial domain representation. The techniques of this disclosure describe how to employ range-Doppler spectrum representation to improve accuracy of localization of 3D object detection, BEV segmentation, and BEV instance segmentation tasks by fusing camera and radar range-Doppler features. Such problems may be addressed by using fusion across spatial (image)-frequency (radar) domain representations.

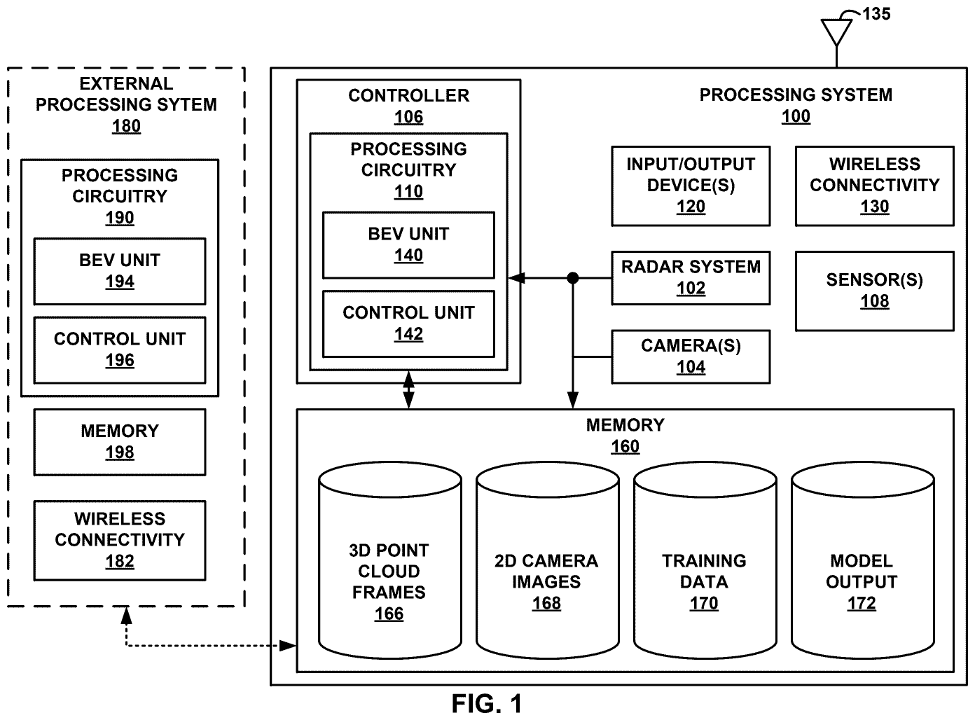

FIG. 1 is a block diagram illustrating an example processing system according to one or more aspects of this disclosure. Processing system 100 may be used in a vehicle, such as an autonomous driving vehicle or an assisted driving vehicle (e.g., a vehicle having an ADAS or an “ego vehicle”). In such an example, processing system 100 may represent an ADAS. In other examples, processing system 100 may be used in robotic applications, VR applications, or other kinds of applications that may include a plurality of sensor systems, such as one or more camera sensors and/or a radar system. The techniques of this disclosure are not limited to any specific sensor setup or to vehicular applications. The techniques of this disclosure may be applied by any system that processes data from a plurality of sensors.

Processing system 100 may include radar system 102, camera(s) 104, controller 106, one or more sensor(s) 108, input/output device(s) 120, wireless connectivity component 130, and/or memory 160. Radar system 102 may include one or more radar emitters/sensors. Radar system 102 may, in some cases, be deployed in or about a vehicle. For example, radar system 102 may be mounted on a roof of a vehicle, in bumpers of a vehicle, and/or in other locations of a vehicle. Radar system 102 may be configured to emit radio waves and sense the radio waves reflected off of objects in the environment. Radar system 102 is not limited to being deployed in or about a vehicle. Radar system 102 may be deployed in or about another kind of object.

In some examples, the one or more emitters of radar system 102 may emit radio waves in a 360-degree field around the vehicle so as to detect objects within the 360-degree field by detecting reflected waves using the one or more radar sensors. For example, radar system 102 may detect objects in front of, behind, or beside radar system 102. The output of radar system 102 may include point clouds or point cloud frames.

A point cloud frame output by radar system 102 is a collection of 3D data points that represent the surface of objects in the environment. Radar processing circuitry of radar system 102 may generate one or more point cloud frames based on the one or more radio waves emitted by radar system 102 and the one or more reflected radio waves sensed by the one or more sensors of radar system 102. These points are generated by measuring the time it takes for a radio wave to travel from an emitter to an object and back to a light detector. Each point in the cloud has at least three attributes: x, y, and z coordinates, which represent its position in a Cartesian coordinate system.

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera(s) 104 may include any type of camera configured to capture video or image data in the environment around processing system 100 (e.g., around a vehicle). In some examples, processing system 100 may include multiple camera(s) 104. For example, camera(s) 104 may include a front facing camera (e.g., a front bumper camera, a front windshield camera, and/or a dashcam), a rear facing camera (e.g., a backup camera), side facing cameras (e.g., cameras mounted in sideview mirrors). Camera(s) 104 may include a color camera or a grayscale camera. In some examples, camera(s) 104 may be a camera system including more than one camera sensor. Sensor(s) 108 may include Light Detection and Ranging (LiDAR) sensors, a location sensor, a sonar sensor, an infrared camera, and/or a time-of-flight (ToF) camera.

Radar system 102 may, in some examples, be configured to collect 3D point cloud frames 166. Camera(s) 104 may, in some examples, be configured to collect 2D camera images 168. An importance of data input modalities such as 3D point cloud frames 166 and 2D camera images 168 may vary for indicating one or more characteristics of objects in a 3D environment. For example, when color and texture are important characteristics of a first object and when color and texture are not important characteristics of a second object, 2D camera images 168 may be more important for identifying characteristics of the first object as compared with the importance of 3D point cloud frames 166 for identifying characteristics of the second object. It may be beneficial to consider the importance of 3D point cloud frames 166 and 2D camera images 168 for indicating characteristics of a 3D environment when generating BEV features corresponding to 3D point cloud frames 166 and/or generating BEV features corresponding to 2D camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135. Processing system 100 may communicate with external processing system and/or processing systems of other devices (e.g., other vehicles) via wireless connectivity component 130.

Processing system 100 may also include one or more input/output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processing circuitry 110. Controller 106 is not limited to controlling vehicles. Controller 106 may additionally or alternatively control any kind of controllable device, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with radar system 102, camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. Sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), and/or another kind of hard disk. Examples of memory 160 include solid state memory and/or a hard disk drive. In some examples, memory 160 is used to store computer-readable, computer-executable software including instructions that, when applied, cause one or more processors to perform various functions described herein. In some cases, memory 160 contains, among other things, a basic input/output system (BIOS) which controls basic hardware or software operation such as the interaction with peripheral components or devices. In some cases, a memory controller operates memory cells of memory 160. For example, the memory controller can include a row decoder, column decoder, or both. In some cases, memory cells within memory 160 store information in the form of a logical state.

Processing system 100 may be configured to perform techniques for extracting features from image data and position data, processing the features, fusing the features, or any combination thereof. In some examples, processing system 100 may perform a portion of such techniques while external processing system 180 may perform another portion of such techniques.

Processing circuitry 110 may include BEV unit 140. BEV unit 140 may be implemented in software, firmware, and/or any combination of hardware described herein. As will be described in more detail below, BEV unit 140 may be configured to receive a plurality of 2D camera images 168 captured by camera(s) 104 and receive a plurality of 3D point cloud frames 166 captured by radar system 102. BEV unit 140 may be configured to receive 2D camera images 168 and 3D point cloud frames 166 directly from camera(s) 104 and radar system 102, respectively, or from memory 160. In some examples, the plurality of 3D point cloud frames 166 may be referred to herein as “position data.” In some examples, the plurality of 2D camera images 168 may be referred to herein as “image data.”

BEV unit 140 may fuse features corresponding to the plurality of 3D point cloud frames 166 and features corresponding to the plurality of 2D camera images 168 in order to combine image data corresponding to one or more objects within a 3D space with position data corresponding to the one or more objects. As such, BEV unit 140 may be configured to fuse encoded point cloud data (e.g., radar data) and encoded image data and generate fused data as described herein. For example, each camera image of the plurality of 2D camera images 168 may comprise a 2D array of pixels that includes image data corresponding to one or more objects. Each point cloud frame of the plurality of 3D point cloud frames 166 may include a 3D multi-dimensional array of points corresponding to the one or more objects. Since the one or more objects are located in the same 3D space where processing system 100 is located, it may be beneficial to fuse features of the image data present in 2D camera images 168 that indicate information corresponding to the identity one or more objects with features of the position data present in the 3D point cloud frames 166 that indicate a location of the one or more objects within the 3D space. This is because image data may include at least some information that position data does not include, and position data may include at least some information that image data does not include.

Fusing features of image data and features of position data may provide a more comprehensive view of a 3D environment corresponding to processing system 100 as compared with analyzing features of image data and features of position data separately. For example, the plurality of 3D point cloud frames 166 may indicate an object in front of a processing system 100, and BEV unit 140 may be able to process the plurality of 3D point cloud frames 166 to determine that the object is a stoplight. This is because the plurality of 3D point cloud frames 166 may indicate that the object includes three round components oriented vertically and/or horizontally relative to a surface of a road intersection, and the plurality of 3D point cloud frames 166 may indicate that the size of the object is within a range of sizes that stoplights normally occupy. But the plurality of 3D point cloud frames 166 might not include information that indicates which of the three lights of the stoplight is turned on and which of the three lights of the stoplight is turned off. 2D camera images 168 may include image data indicating that a green light of the stoplight is turned on, for example. This means that it may be beneficial to fuse features of image data with features of position data so that BEV unit 140 can analyze image data and position data to determine characteristics of one or more objects within the 3D environment.

Fusing image data BEV features and position data BEV features may include associating image data BEV features with position data BEV features corresponding to the image data BEV features. For example, processing system 100 may fuse image data BEV features indicating a color and an identity of a stoplight with position data BEV features indicating a position of the stoplight. This means that the fused set of BEV features may include information from both image data and position data corresponding to the stoplight that is important for generating an output. Some systems may fuse image data BEV features with position data BEV features by generating “grids” of image data BEV features with position data BEV features and fusing the grids. A BEV feature grid may correspond to a 2D BEV of a 3D environment. Each “cell” of the BEV feature grid may include features corresponding to a portion of the 3D environment corresponding to the cell. This allows the system to fuse image data BEV features with position data BEV features corresponding to the same portion of the 3D environment.

Control unit 142 may control the device based on information included in the fused BEV representations relating to one or more objects within a 3D space including processing system 100. For example, the fused BEV representations and/or the output of BEV unit 140 may include an identity of one or more objects, a position of one or more objects relative to the processing system 100, characteristics of movement (e.g., speed, acceleration) of one or more objects, or any combination thereof. Based on this information, control unit 142 may control the device corresponding to processing system 100. The fused BEV representations may be stored in memory 160 as model output 172.

External processing system 180 may represent one or more servers in a cloud computing environment and/or a roadside unit. External processing system 180 may obtain (e.g., receive) data from processing system 100 and/or similar processing systems and process the received data, for example, to determine uncertainty associated with a detected object and/or to train one or more encoders and/or decoders of BEV unit 140.

External processing system 180 may include processing circuitry 190, which may be any of the types of processors described above for processing circuitry 110. Processing circuitry 190 may include a BEV unit 194 configured to fuse encoded radar data (e.g., point cloud data) and encoded image data and generate fused data as described herein. Processing circuitry 190 may obtain data from controller 106 or from memory 160. External processing system 180 may also include memory 198 that may be configured to store data obtained from processing system 100 and other similar processing systems. Memory 198 may also be configured to store training data (similar to training data 170) and model output (similar to model output 172) for encoders, decoders, or other models that are part of BEV unit 194. Memory 198 may include any of the types of memory described above for memory 160.

Wireless connectivity component 182 may facilitate communication between external processing system 180 and processing system 100. Wireless connectivity component 182 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards.

In some examples, processing circuitry 110 may be configured to train one or more encoders, decoders, or any combination thereof applied by BEV unit 140 using training data 170. For example, training data 170 may include sensor data such as one or more training point cloud frames and/or one or more camera images. Training data 170 may additionally or alternatively include features known to accurately represent one or more point cloud frames and/or features known to accurately represent one or more camera images. This may allow processing circuitry 110 to train one or more encoders to generate features that accurately represent point cloud frames and train one or more encoders to generate features that accurately represent camera images. Processing circuitry 110 may also use training data 170 to train one or more decoders. In some examples, training data 170 may be stored separately from processing system 100. In some examples, processing circuitry other than processing circuitry 110 and/or processing circuitry 190 and separate from processing system 100 may train one or more encoders, decoders, or any combination thereof applied by BEV unit 140 using training data 170.

In some examples, processing circuitry 110 may train one or more encoders and/or decoders of BEV unit 140.

In some examples, training data 170 may be stored in memory 198. In some examples, external processing system 180 may update BEV unit 140 via wireless connectivity component 182 and wireless connectivity component 130 based on the trained encoder(s) and/or decoder(s) of BEV unit 194.

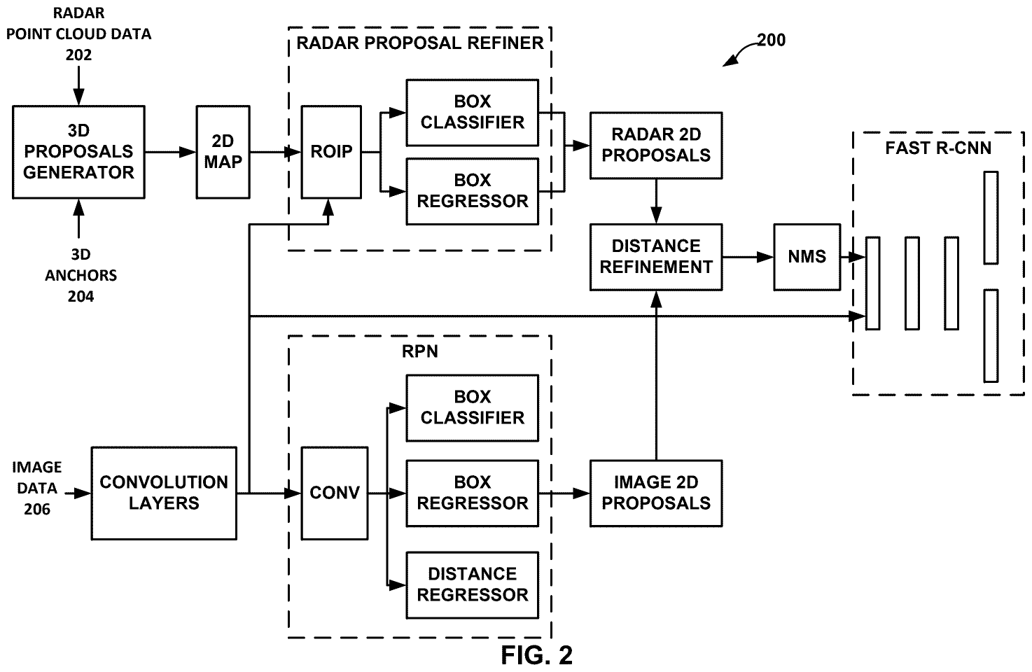

FIG. 2 is a block diagram illustrating an example network architecture. Architecture 200 may obtain inputs including radar point cloud data 202, 3D anchors 204, and image data 206.

Architecture 200 may include volumetric features from a multi-camera setup. Architecture 200 may include camera-radar fusion by BEV fusion using 2 stages. In some examples, processing system 100 may perform camera-radar BEV fusion using SimpleBEV using bilinear interpolation during the lifting step. This lifting step may be improved as described herein in the radar branch by using a radar specific transformer query mechanism.

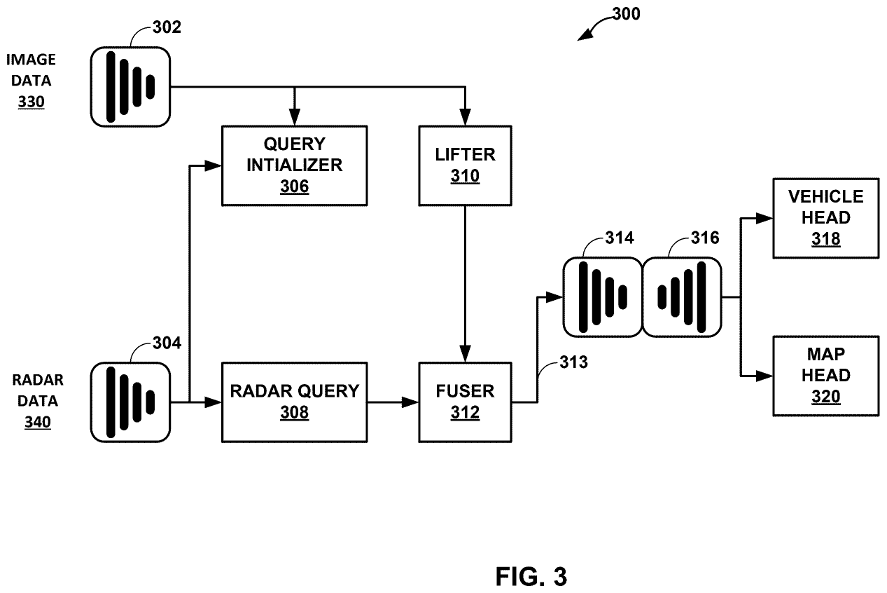

FIG. 3 is a block diagram illustrating an example baseline BEV fusion architecture. Architecture 300 of FIG. 3 encodes the modality-specific inputs (image data 330 and radar data 340) separately. Encoder 302 may encode image data 330, while encoder 304 may encode radar data 340. Query initializer 306 may lift the image features output by encoder 302 into BEV space to generate values for the attention mechanism that utilizes radar to query from these lifted image features. Radar query 308 may represent radar queries. After the feature encoding of both modalities, the visual features undergo the view transformation in the lifting stage (lifter 310). Lifted image features are fused (e.g., by fuser 312) with the radar features leveraging deformable attention. In some examples, architecture 300 utilizes six transformer blocks for the lifting and fusing. The resulting BEV features 313 are fed through an encoder 314, which may include a ResNet, for example. Encoder 314 may generate a ResNet-based bottleneck that reduces the spatial resolution of the BEV feature space. Architecture 300 apply decoder 316 to the output of encoder 314 and may send the decoded BEV features to vehicle head 318 and to map head 320. In some examples, architecture 300 may be said to employ a middle fusion approach, where the modalities are fused on a feature level.

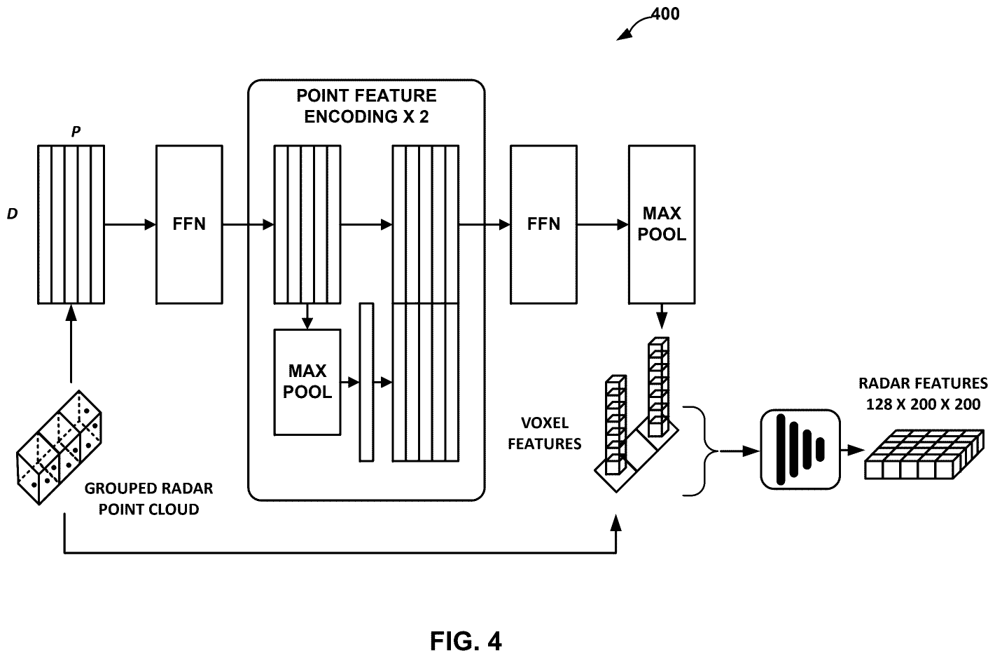

FIG. 4 is a block diagram illustrating an example baseline radar point cloud to BEV feature encoder. Encoder 400 may include a point-to-voxel encoder and may encode the radar data in a point-wise manner and use max pooling to combine point features within a voxel. Encoder 400 may employ a CNN-based height compression to obtain overall radar features in the BEV space.

Lifting BEV features from multi-camera BEV features using spatial radar representations may be a challenge due to sparsity of radar point clouds spatially. As such, a spectro-spatial transformer-based multimodal camera-radar fusion system using radar Doppler spectrum dense feature representations with BEV features from camera(s) 104 may better avoid instability or sparsity of radar point clouds in the spatial domain.

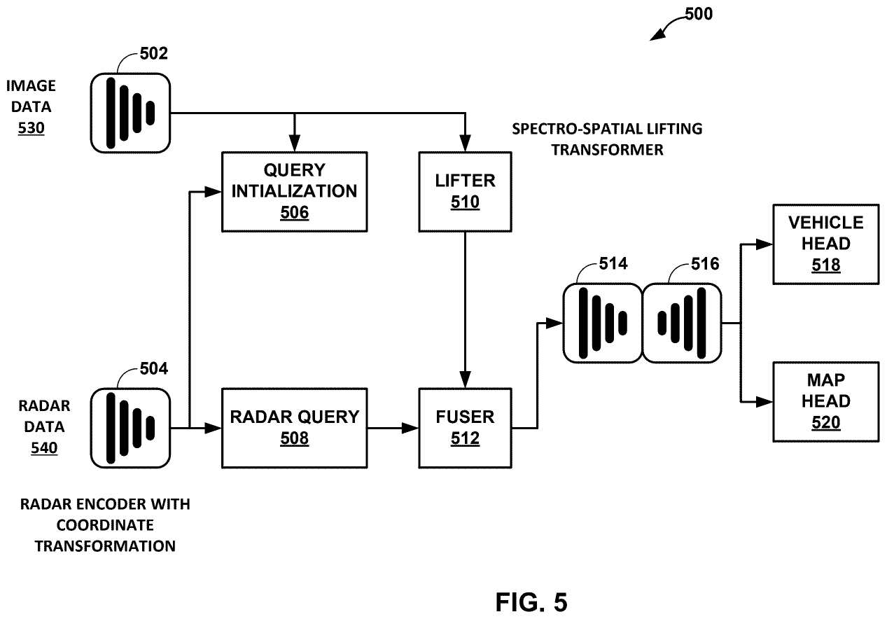

FIG. 5 is a block diagram illustrating an example BEV fusion architecture according to one or more aspects of this disclosure. In the example of FIG. 5, radar encoder 504 may include a radar encoder with coordinate transformation. Architecture 500 may encode modality-specific inputs (image data 530 and radar data 540) separately.

A number of elements of architecture 500 may be similar to those of architecture 300 of FIG. 3 described above. For example, image input data 530 may be similar to image input data 330, query initializer 506 may be similar to query initializer 306, lifter 510 may be similar to lifter 310, radar query 508 may be similar to radar query 308, fuser 512 may be similar to fuser 312, encoder 514 may be similar to encoder 314, decoder 516 may be similar to decoder 316, vehicle head 518 may be similar to vehicle head 318, and map head 520 may be similar to map head 320. Other elements of architecture 500 may be different than those of architecture 300.

For example, input to encoder 504 may include radar data 540 in the form of a range-Doppler cuboid. The range-Doppler cuboid of radar data 540 may include a cuboid of (a first number of range bits)×(a second number of range bits)×(a number of Doppler bits). Range-Doppler is an intermediate spectrum and may include a frequency cube.

Encoder 504 may be configured to use Fourier or range-Doppler features instead of using spatial features. Encoder 504 may encode the features in the Fourier domain. By encoding features in the Fourier domain, features may be persevered in the radar data that may otherwise be lost if spatial domain radar data was input to an encoder, like encoder 304 of FIG. 3. Encoder 504 may include a coordinate transformer configured to transform encoded radar data from the Fourier domain into the spatial domain.

Encoder 502 may encode image data 530. In some examples, encoder 502 includes a modified ResNet-50 that operates on a number of camera images per batch and generates features at one or more fractions of the input resolution. For example, encoder 302 may encode six camera images per batch and generate features at ¼, ⅛, and 1/16 of the input resolution (e.g., a height of 448 and a width of 800) with 128 channels each.

In some examples, there may be two feature maps with ⅛ of the input resolution. While all feature maps may be used for the lifting transformer, in some examples, only the last feature map for the query initialization (e.g., by query initializer 506). The last feature map may be the only layer used because the last layer already incorporates information of the previous multi-level features to some extent, which may be sufficient for query initializer 506 to perform the initialization.

Because architecture 500 may employ middle-fusion techniques, it may be desirable to fuse the radar and camera information in a shared BEV feature space. By fusing the radar and camera information in a shared BEV feature space, architecture 500 may make dense semantic predictions on other vehicles and the map surrounding the ego vehicle. Radar data 540 may be provided in the form of a continuous point cloud in a spatial domain. As such, architecture 500 may discretize radar data 540 to the voxel grid of the feature space.

Encoder 504 may include, for example, a ResNet18-based radar encoder, a Minkowki Engine in the form of a UResNet configured to perform sparse convolutions, or a Point2Voxel Encoder. In some examples, radar data 540 (e.g., range-doppler cuboid) may include a number of features per measurement (e.g., 19 features per measurement), which may provide much richer information than a normal x, y, 2-point cloud.

A radar point may be defined as pr=xᵢ, yᵢ, Zᵢ, vₓᵢ, v_{y}i, RCSᵢ. Architecture 500 may not rely on all the provided metadata. Thereby, (xᵢ, yᵢ, zᵢ.) represents the position of the radar measurement in the reference frame, which may be considered to be the front-facing camera at inference. The velocity is captured in (vₓᵢ, v_{yi}) and may be an uncompensated velocity value without considering the velocity of the ego vehicle. Radar cross-section (RCS) may be considered an additional feature. A higher RCS value generally corresponds to an object being detected more easily. Using all 19 features would require respective post-processing steps which may consume computational resources. As such, encoder 504 may use basic radar information and a decoder may learn descriptive features that support the desired tasks of semantic map generation and object segmentation.

In examples where encoder 504 includes a ResNet18-based radar encoder, the point cloud may be voxelized by generating an occupancy map of the same size as the desired BEV 3D feature space, (e.g., 200×8×200), in the coordinate frame of the reference camera. Radar points exceeding the restricted area need not be further considered. After the mapping, every cell that contains a radar point may be considered to be occupied. In this manner, architecture 500 may generate a radar representation that is already in BEV space and can be encoded by a convolution-based encoder network. Encoder 504 may be closely related to the image backbone, but use fewer layers. Encoder 504 may obtain the discretized radar data of a predetermined shape (e.g., 32×200×200), generate multi-scale features of ½, ¼, and ⅛ and aggregate them with upsampling layers resulting in a radar feature representation of e.g., (128×200×200).

Because the radar data is considered to be sparse, resulting in most cells of the occupancy map being empty, in some examples, encoder 504 includes a Minkowki Engine in the form of a UResNet, to optimize or improve operations. For example, encoder 504 may include a ResNet18-based UNet that leverages optimized convolution layers for the voxelized radar input to generate a feature space of a size (e.g., 128×200 ×200).

In examples where encoder 504 includes a Point2Voxel Encoder, instead of directly computing features on discrete grid cells, encoder 304 may include a multistep encoder that works on continuous point clouds. In such examples, encoder 504 may encode point-wise features before discretizing them into voxel features that represent the radar BEV features. In such examples, the radar data point cloud is partitioned into voxels that represent the area of the desired BEV space. According to their coordinates, each point may be assigned to one cell. Encoder 504 may randomly sample a number of points (e.g., P=10 points) from voxels that exceed this limit, to not add a bias and restrict the memory need. For reducing the memory footprint, input data may not represented in a Cartesian grid, but instead be a dense tensor representation to avoid hundreds of empty voxels that do not contribute any learning. The dense input representation is a tensor of shape N×P×D. With N representing the maximum expected number of non-empty voxels, for example, N=800 and P=10 points per voxel, each having, for example, D=7 input features. Therefore, the following computations may only be conducted on the relevant voxels.

After the points per voxel are selected, encoder 504 may encode each point including the point's metadata in point feature encoding layers. Hereby, every point is encoded by a fully connected network without interchanging information with neighboring points or voxels. All point features of their respective voxel may be augmented via concatenation by a combined feature representation gained by MaxPooling over all features of that voxel. The enhanced point features may be passed through an FNN followed by a per voxel MaxPooling to condense the information into a single tensor per voxel. Afterward, the encoded features may be converted from the dense feature representation back to the Cartesian voxel grid to relate the information of neighboring voxels. This information exchange of neighboring voxels may be achieved by utilizing several CNN layers. In some examples, encoder 504 may provide a feature space of 128×200×200 for radar data 540.

Lifter 510 utilize self-attention and cross-attention to transform the image features output by encoder 502 into the BEV. Lifter 510 may include three main layers per transformer block. Lifter 510 may refine the input query via deformable self-attention followed by a cross-attention layer. An FFN layer adds additional non-linearity to encode the BEV features independent of their coordinate. Between all mentioned layers, lifter 510 may utilize LayerNorm and make use of skip connections for the queries throughout. Lifter 510 may utilize an advanced deformable attention mechanism to perform the actual lifting.

Architecture 500 may utilize the BEV queries Q_{lift} to query image information from all feature maps (e.g., six feature maps) in perspective view to generate BEV features. The BEV features may contain the lifted image features in BEV space and act as the query for the next self-attention layer of the upcoming transformer block. In some examples, lifter 510 may initialize Q_{lift} with pseudo-lifted image features that are then guided by radar to incorporate depth information and refine the initial query to improve the lifted image features. In some examples, architecture 500 may also use learnable queries and learnable positional encoding.

Query initializer 506 may lift the image features output by encoder 502 into BEV space to generate values for the attention mechanism that utilizes radar to query from these lifted image features. For example, architecture 500 may create a voxel space with dimensions, e.g., (6×200×8×200) that represents the space of interest with respect to the ego vehicle. In some examples, the dimensions may have a resolution of 0.5 m in Z-and X-axis and 1.0 m in Y-axis. That volumetric space may be centered in the reference frame of the reference camera, which may be considered to be the front-facing camera, as V^{cref}. In a series of coordinate transformations, query initializer 506 may transform V into the reference frame of each camera's sensor plane. Given the transformation matrices T_{cref}^{cs} and T_{cs}^{fp}, query initializer 506 may retrieve the transformation from the frame of the reference camera to the continuous pixel coordinates of each camera as TIP cref.

With this new transformation matrix, query initializer 506 may transform V into the pixel frames.

$$\begin{matrix}{T}_{cref}^{fp} = {T}_{cs}^{fp} {T}_{cref}^{cs} \\ {V}^{fp} = {T}_{cref}^{fp} {V}^{cref}\end{matrix}$$

Normalization of the homogeneous coordinates results in the continuous pixel coordinates for each voxel. For every view, query initializer 506 creates a mask that stores the indices of valid voxels, e.g., voxels that are projected, but do not exceed the area of the sensor. After the normalization, query initializer 506 expands the 2D pixel coordinates along the depth dimension, to generate a 3D grid G^{fp} that builds the space to where the image features are projected. Using a bilinear grid sampling operation, query initializer 506 may project the image features from, for example, H/8×W/8 to 8×200 along their projection ray into 200 voxels in depth, resulting in a (6×128×200×8×200) feature space. Query initializer 506 may then filter for valid features with the previously defined voxel mask and combine the feature spaces of all cameras into one feature space. Query initializer 506 may combine overlapping regions between cameras by calculating the mean over the features. Query initializer 506 may compress the combined feature space along the height dimension via a ×1 convolution to generate a BEV feature space of size 128×200×200. At this stage, the image features may be uniformly projected along their projection rays without any consideration of their actual position in the depth of the BEV space.

Lifter 510 may perform lifting by adapting the deformable attention module from query initializer 506. Instead of sampling around the query point in the 2D BEV plane, lifter 510 may extend this sampling operation into 3D. Here, the BEV plane is expanded in height, corresponding to the 3D voxel space from the lifting stage in the query initialization of query initializer 506. In some examples, lifter 510 generates eight discrete reference points in 3D that may be viewed as a pillar. Lifter 510 may transform these eight reference points into the image plane of the corresponding camera view into 2D continuous pixel coordinates. For each of these reference points, lifter 510 may predict one offset that is added on top to retrieve the corresponding image feature value.

Fuser 512 may include a six-block transformer architecture to combine lifted image features with the encoded radar data (e.g., from radar query 508). Fuser 512 may obtain a query that is now initialized with radar features in the BEV space, as well as learnable queries and learnable positional encoding referred to as Q_{fuse}. The transformer block of fuser 512 may include three main parts, a self-attention layer, a cross-attention layer, as well as a fully connected layer at the end. Normalization layers and skip connections may follow common principles and be designed similarly to the lifting module.

For example, fuser 512 may pass the radar query through the self-attention layer to refine the query, followed by the cross-attention layer. Fuser 512 may use O_{fuse} to query image features in surrounding positions and extract values of the image features via deformable attention. In some examples, fuser 512 may do so over six transformer blocks, where the output features from the lifting stage are fused via cross-attention in each block to refine the BEV query. The radar query and the lifted image features may be considered as values, resulting in BEV fused.

Because the fused features are not spatially reduced in the latent query representation, decoder 516 may include a ResNet-based UNet-shaped decoder network to compress the spatial dimension of the fused BEV representation up to a fraction (e.g., ⅛) of the input resolution.

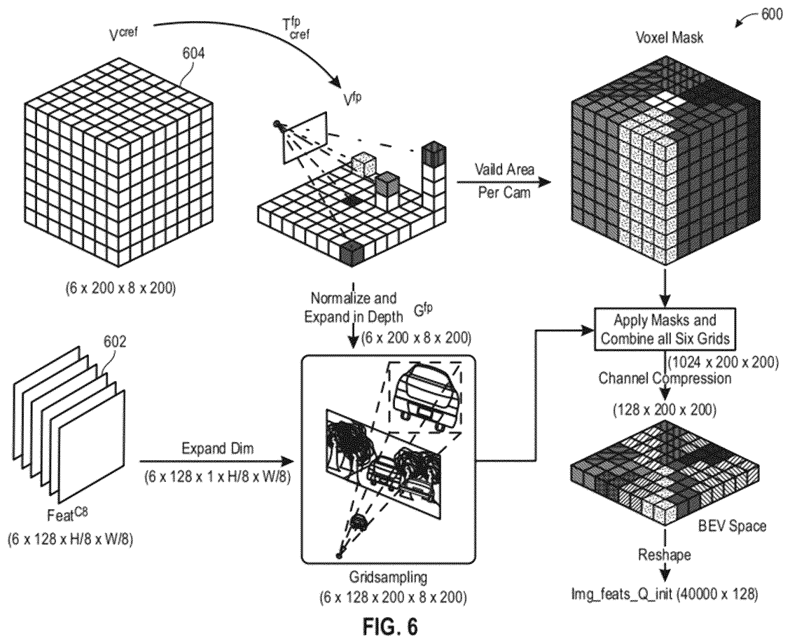

FIG. 6 is a functional diagram illustrating an example query initializer according to one or more aspects of this disclosure. Query initializer 600 may be an example of query initializer 506 (FIG. 5) and/or query initializer 306 (FIG. 3). In the example of FIG. 6, a system may use spectral, Fourier domain features instead of spatial domain features when lifting from perspective view to BEV.

Processing system 100 may lift image features 602 (which may be output by encoder 502 of FIG. 5) into BEV space to generate values for the attention mechanism that utilizes radar data to query from these lifted image features. The process of the unprojection is visualized in FIG. 6 for query initialization. For example, processing system 100 may create a voxel space 604 with, for example, the dimensions 6×200×8 ×200 that represents the space of interest with respect to processing system 100 (e.g., an ego-vehicle) with a resolution of 0.5 m in Z-and X-axis and 1.0 m in Y-axis. Voxel space 604 may be centered in the reference frame of the reference camera, which may be a front-facing camera, as V^{cref}. In a series of coordinate transformations, processing system 100 may transform V into the reference frame of each camera's sensor plane.

Given the transformation matrices T_{cref}^{cs} and T_{cs}^{fp}, query initializer 506 may retrieve the transformation from the frame of the reference camera to the continuous pixel coordinates of each camera as T_{cref}^{fp}. With this new transformation matrix, query initializer 506 may transform V into the pixel frames.

$$\begin{matrix}{T}_{cref}^{fp} = {T}_{cs}^{fp} {T}_{cref}^{cs} \\ {V}^{fp} = {T}_{cref}^{fp} {V}^{cref}\end{matrix}$$

Normalization of the homogeneous coordinates results in the continuous pixel coordinates for each voxel. For every view, query initializer 506 may create a mask that stores the indices of valid voxels, e.g., voxels that are projected, but do not exceed the area of the sensor. After the normalization, query initializer 506 expands the 2D pixel coordinates along the depth dimension, to generate a 3D grid G^{fp} that builds the space to where the image features are projected. Using a bilinear grid sampling operation, query initializer 506 may project the image features from, for example, H/8×W/8 to 8×200 along their projection ray into 200 voxels in depth, resulting in a (6×128×200×8×200) feature space. Query initializer 506 may then filter for valid features with the previously defined voxel mask and combine the feature spaces of all cameras into one feature space. Query initializer 506 may combine overlapping regions between cameras by calculating the mean over the features. Query initializer 506 may compress the combined feature space along the height dimension via a 1×1 convolution to generate a BEV feature space of size 128×200×200. At this stage, the image features may be uniformly projected along their projection rays without any consideration of their actual position in the depth of the BEV space. For example, the identical features spread out with increasing distance from their viewpoint.

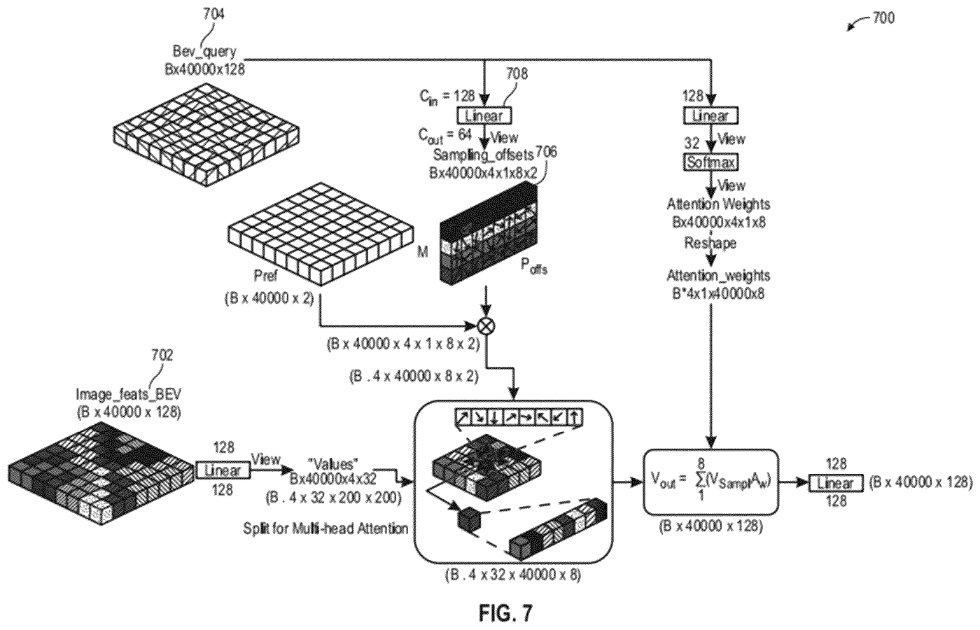

FIG. 7 is a functional diagram illustrating an example query initializer according to one or more aspects of this disclosure. In the example of FIG. 7, a system may use spectral, Fourier domain features instead of spatial domain features when lifting from perspective view to BEV.

Architecture 500 may refine the image features 702 spatially by incorporating depth information in the form of radar feature maps that query the image features across the BEV plane. Architecture 500 may transform the radar as well as the image features into the desired shape of the transformer architecture, which may be achieved by flattening the 2D BEV representation into a single dimension, e.g., 40000×128. Architecture 500 may employ deformable attention of FIG. 7. This deformable attention may be used for all self-attention layers, as well as the cross-attention layers in fuser 512 because such layers are in the BEV frame. In some examples, for self-attention, the current query may be used for both inputs in FIG. 7. The radar BEV query 704 may be used to generate sampling offsets 706 that are later used for the sparse attention mechanism to combine the information of radar BEV query 704 and image features 702 in the BEV feature space. Sampling offsets 706 may be generated by linear layer 708, that reduces the number of channels down to M×P×2 where M represents the four heads for multi-head attention and P represents the eight sampling points per query point of a BEV grid. This feature representation is visualized in a) where all learned sampling offsets are shown for one query point. To relate these sampling points to the actual BEV coordinates, architecture 500 may add the sampling points to the reference grid (b)) that represents the BEV space spatially. After normalization, this produces a grid that may be used to sample points from the image BEV features. Therefore, the image features may be reshaped from their query shape back into their spatial representation of, for example, (B-4×32×200×200). Now, for every query point, architecture 500 utilizes the respective eight sampling points to gather the values around that same coordinate in the image BEV space via bilinear interpolation, resulting in eight values from the image features per radar query point. For the actual attention mechanism, architecture 500 may generate attention weights from the radar query via a linear layer that reduces the feature dimensionality from Cᵢₙ=128 to Cᵢₙ=32 for having an attention weight for every sampling point for each head M×P. The attention mechanism may multiply the attention weights for one query point with the corresponding value point for all 32 dimensions. After summation over all eight points, architecture 500 may feed the attention output through a last linear layer to generate the desired output of the data-driven query initialization, of shape, for example, (B×40000×128) as an initialized lifting query. Additionally, learnable queries for the features themselves and for positional embedding may be added. That combined query resembles the input Quin of lifter 510.

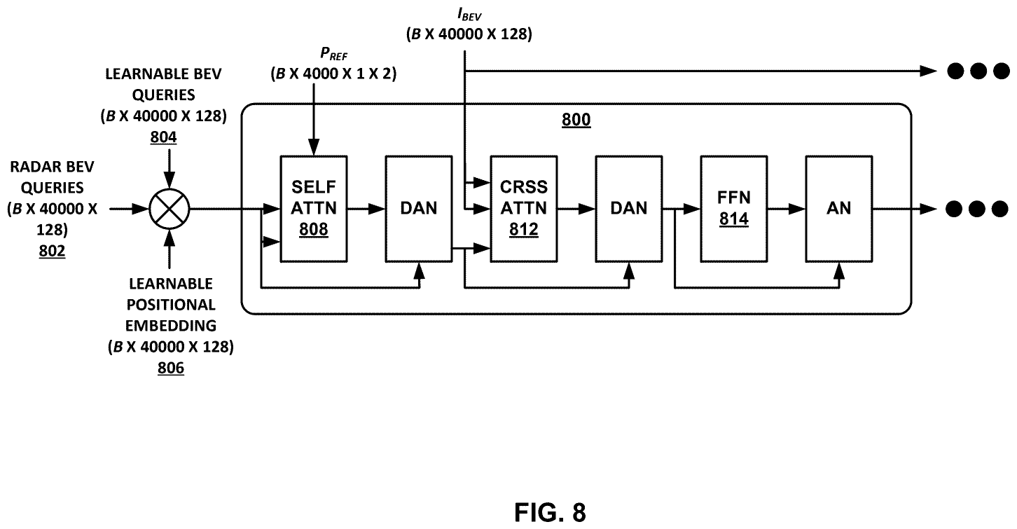

FIG. 8 is a block diagram of an example single fusion transformer block according to one or more aspects of this disclosure. Block 800 may be a part of fuser 512 (FIG. 5) and/or fuser 312 (FIG. 3). The fusion transformer of which block 800 is a part may include a camera-radar BEV fusion transformer. FIG. 8 includes self-attention layer 808, cross-attention layer 812, feedforward neural network (FFN) 814, deep averaging networks (DAN), and an artificial neural network (AN).

The fusion transformer may include use a six-block transformer architecture, which may combine lifted image features with the encoded radar data (e.g., spectral features from the radar data). Block 800 may be one such block of the six-block transformer architecture. Block 800 may be repeated for the other five blocks of the six-block transformer architecture.

For example, the fusing stage may start with radar BEV queries 802 that are initialized with radar features in the BEV space, as well as learnable BEV queries 804, and learnable positional embedding 806 (which may be referred to as Q_{fuse}). The transformer block may include three main parts: a self-attention layer 808, a cross-attention layer 812, and a fully connected layer FFN 814. Normalization layers and skip connections follow common principles and may be similarly designed to lifter 510 (FIG. 5) and/or lifter 310 (FIG. 3).

For example, block 800 may pass radar BEV queries 802 through self-attention layer 808 to refine the queries, followed by the cross-attention layer 812. Block 800 may use Q_{fuse} to query image features in surrounding positions and extract values of the image features via deformable attention. In some examples, a fuser may do so over six transformer blocks, such as block 800, where the output features (such as Pref and/or Ibev) from the lifting stage are fused via cross-attention layer 812 in each block to refine the radar BEV queries. The radar data may be considered as queries and the lifted image features may be considered as values, resulting in BEV_{fused}.

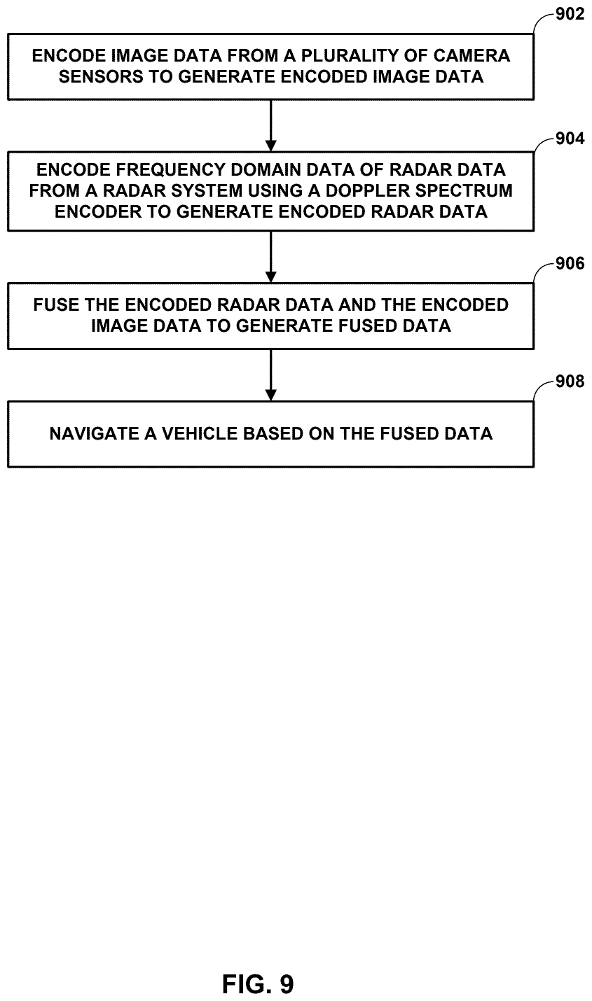

FIG. 9 is a flow diagram illustrating example camera-radar spatio-spectral BEV query techniques according to one or more aspects of this disclosure. Processing circuitry 110 may encode image data from a plurality of camera sensors to generate encoded image data (902). For example, encoder 502 may encode image data 530 from camera(s) 104.

Processing circuitry 110 may encode frequency domain data of radar data from a radar system using an encoder to generate encoded radar data (904). For example, encoder 504 may encode frequency domain data including radar data 540 (e.g., a range-Doppler cuboid) from radar system 102.

Processing circuitry 110 may fuse the encoded radar data and encoded image data to generate fused data (906). For example, fuser 512 may fuse the encoded radar data and encoded image data processing circuitry 110.

Processing circuitry 110 may navigate a vehicle based on the fused data (908). For example, processing circuitry 110 may navigate a vehicle (e.g., processing system 100) via vehicle head 518 and/or map head 520.

In some examples, the frequency domain data includes a range-Doppler cuboid and the encoder includes a Doppler spectrum encoder. In some examples, processing circuitry 110 (e.g., query initialization 506) may perform a query initialization on a query, the query initialization including lifting image features of the encoded image data into a bird's-eye-view (BEV) space to generate lifted image features. In some examples, processing circuitry 110 may perform a query using the encoded radar data to query the lifted image features. In some examples, as part of performing the query initialization, processing circuitry 110 may refine uniformly unprojected image features of the query utilizing deformable attention. In some examples, processing circuitry 110 (e.g., lifter 510) may lift multiscale image features via a lifting transformer to generate lifted BEV features. In some examples, as part of fusing the encoded radar data (e.g., point cloud data) and encoded image data, processing circuitry 110 may use the lifted BEV features as input values to a fusion transformer (e.g., of fuser 512) that uses radar BEV features as the query. In some examples, as part of fusing the encoded radar data and the encoded image data, processing circuitry 110 may combine the lifted image features and the encoded radar data.

In some examples, processing circuitry 110 may fuse the encoded radar data and the encoded image data is based on learnable BEV queries, radar BEV queries, and learnable positional embedding. In some examples, the Doppler spectrum encoder includes a neural network encoder. In some examples, the Doppler spectrum encoder comprises a ResNet 18 encoder, a Minkwoski Engine, or a Point2Voxel encoder.

According to the techniques of this disclosure, a Doppler spectrum encoder directly takes as input the spectral frequency domain input from radar system 102 and evaluates a spatial domain query. The output from the range Doppler spectrum encoder may have a dense frequency domain input and may provide stable features to extract more discriminant BEV features from the camera domain and may provide a better 2D-3D/BEV lifting query function.

Additional aspects of the disclosure are detailed in numbered clauses below.

Clause 1A. A system for processing data, the system comprising: one or more memories for storing point cloud data from a radar system and image data from a plurality of camera sensors; and one or more processors in communication with the one or more memories, the one or more processors configured to: encode the image data to generate encoded image data; encode the point cloud data comprising performing a coordinate transformation to generate encoded point cloud data; fuse the encoded point cloud data and encoded image data to generate fused data; and navigate a vehicle based on the fused data.

Clause 2A. The system of clause 1A, wherein performing the coordinate transformation comprises applying a fast Fourier transform to the point cloud data.

Clause 3A. The system of clause 1A or clause 2A, wherein the one or more processors are further configured to perform a query initialization, the query initialization comprising lifting image features of the encoded image data into a bird's-eye-view space to generate lifted image features.

Clause 4A. The system of clause 3A, wherein the one or more processors are further configured to perform a query, the query comprising using the encoded point cloud data to query the lifted image features.

Clause 5A. The system of clause 4A, wherein as part of fusing the encoded point cloud data and the encoded image data, the one or more processors are configured to combine the lifted image features and the encoded point cloud data.

Clause 6A. The system of any of clauses 1A-5A, wherein the one or more processors are configured to fuse the encoded point cloud data and the encoded image data based on learnable BEV queries, learnable radar BEV queries, and learnable positional embedding.

Clause 7A. The system of any of clauses 1A-6A, wherein as part of encoding the point cloud data, the one or more processors are configured to apply a Doppler spectrum encoder.

Clause 8A. The system of clause 7A, wherein the Doppler spectrum encoder is configured to obtain a frequency domain input of the point cloud data and evaluate a spatial domain query.

Clause 9A. A method for processing data, the method comprising the techniques performed by the device of any of clauses 1A-8A.

Clause 10A. Non-transitory computer-readable media storing instructions, which, when executed by one or more processors, cause the one or more processors to perform any of the techniques of clause 9A.

Clause 1B. A system for processing data, the system comprising: one or more memories for storing radar data from a radar system, the radar data comprising frequency domain data, and image data from a plurality of camera sensors; and one or more processors in communication with the one or more memories, the one or more processors configured to: encode the image data to generate encoded image data; encode the frequency domain data using an encoder to generate encoded radar data; fuse the encoded radar data and the encoded image data to generate fused data; and navigate a vehicle based on the fused data.

Clause 2B. The system of clause 1B, wherein the frequency domain data comprises a range-Doppler cuboid and the encoder comprises a Doppler spectrum encoder.

Clause 3B. The system of clause 1B or clause 2B, wherein the one or more processors are further configured to perform a query initialization on a query, the query initialization comprising lifting image features of the encoded image data into a bird's-eye-view (BEV) space to generate lifted image features.

Clause 4B. The system of clause 3B, wherein the one or more processors are further configured to perform the query, the query comprising using the encoded radar data to query the lifted image features.

Clause 5B. The system of clause 3B or clause 4B, wherein as part of performing the query initialization, the one or more processors are configured to refine uniformly unprojected image features of the query utilizing deformable attention.

Clause 6B. The system of clause 5B, wherein the one or more processors are further configured to lift multiscale image features via a lifting transformer to generate lifted BEV features and wherein as part of fusing the encoded radar data and the encoded image data, the one or more processors are configured to use the lifted BEV features as input values to a fusion transformer that uses radar BEV features as the query.

Clause 7B. The system of any of clauses 3B-6B, wherein as part of fusing the encoded radar data and the encoded image data, the one or more processors are configured to combine the lifted image features and the encoded radar data.

Clause 8B. The system of any of clauses 1B-7B, wherein the one or more processors are configured to fuse the encoded radar data and the encoded image data based on learnable BEV queries, radar BEV queries, and learnable positional embedding.

Clause 9B. The system of any of clauses 1B-8B, wherein the Doppler spectrum encoder comprises a neural network encoder.

Clause 10B. The system of any of clauses 1B-8B, wherein the Doppler spectrum encoder comprises a ResNet 18 encoder, a Minkwoski Engine, or a Point2Voxel encoder.

Clause 11B. A method for processing data, the method comprising: encoding image data from a plurality of camera sensors to generate encoded image data; encoding frequency domain data of radar data from a radar system using an encoder to generate encoded radar data; fusing the encoded radar data and the encoded image data to generate fused data; and navigating a vehicle based on the fused data.

Clause 12B. The method of clause 11B, wherein the frequency domain data comprises a range-Doppler cuboid and the encoder comprises a Doppler spectrum encoder.

Clause 13B. The method of clause 11B or clause 12B, further comprising performing a query initialization on a query, the query initialization comprising lifting image features of the encoded image data into a bird's-eye-view (BEV) space to generate lifted image features.

Clause 14B. The method of clause 13B, further comprising performing the query comprising using the encoded radar data to query the lifted image features.

Clause 15B. The method of clause 13B or clause 14B, wherein performing the query initialization, comprises refining uniformly unprojected image features of the query utilizing deformable attention.

Clause 16B. The method of clause 15B, further comprising lifting multiscale image features via a lifting transformer to generate lifted BEV features and wherein fusing the encoded radar data and the encoded image data comprises using the lifted BEV features as input values to a fusion transformer that uses radar BEV features as the query.

Clause 17B. The method of any of clauses 13B-16B, wherein fusing the encoded radar data and the encoded image data comprises combining the lifted image features and the encoded radar data.

Clause 18B. The method of any of clauses 11B-17B, wherein fusing the encoded radar data and the encoded image data is based on learnable BEV queries, radar BEV queries, and learnable positional embedding.

Clause 19B. The method of any of clauses 11B-18B, wherein the Doppler spectrum encoder comprises a ResNet 18 encoder, a Minkwoski Engine, or a Point2Voxel encoder.

Clause 20B. Non-transitory computer-readable media storing instructions, which, when executed by one or more processors, cause the one or more processors to: encode image data from a plurality of camera sensors to generate encoded image data; encode frequency domain data of radar data from a radar system using an encoder to generate encoded radar data; fuse the encoded radar data and the encoded image data to generate fused data; and navigate a vehicle based on the fused data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system for processing data, the system comprising:
one or more memories for storing radar data from a radar system, the radar data comprising frequency domain data, and image data from a plurality of camera sensors; and
one or more processors in communication with the one or more memories, the one or more processors configured to:
encode the image data to generate encoded image data;
encode the frequency domain data using an encoder to generate encoded radar data;
fuse the encoded radar data and the encoded image data to generate fused data; and
navigate a vehicle based on the fused data.

2. The system of claim 1, wherein the frequency domain data comprises a range-Doppler cuboid and the encoder comprises a Doppler spectrum encoder.

3. The system of claim 1, wherein the one or more processors are further configured to perform a query initialization on a query, the query initialization comprising lifting image features of the encoded image data into a bird's-eye-view (BEV) space to generate lifted image features.

4. The system of claim 3, wherein the one or more processors are further configured to perform the query, the query comprising using the encoded radar data to query the lifted image features.

5. The system of claim 3, wherein as part of performing the query initialization, the one or more processors are configured to refine uniformly unprojected image features of the query utilizing deformable attention.

6. The system of claim 5, wherein the one or more processors are further configured to lift multiscale image features via a lifting transformer to generate lifted BEV features and wherein as part of fusing the encoded radar data and the encoded image data, the one or more processors are configured to use the lifted BEV features as input values to a fusion transformer that uses radar BEV features as the query.

7. The system of claim 3, wherein as part of fusing the encoded radar data and the encoded image data, the one or more processors are configured to combine the lifted image features and the encoded radar data.

8. The system of claim 1, wherein the one or more processors are configured to fuse the encoded radar data and the encoded image data based on learnable BEV queries, radar BEV queries, and learnable positional embedding.

9. The system of claim 1, wherein the Doppler spectrum encoder comprises a neural network encoder.

10. The system of claim 1, wherein the Doppler spectrum encoder comprises a ResNet 18 encoder, a Minkwoski Engine, or a Point2Voxel encoder.

11. A method for processing data, the method comprising:
encoding image data from a plurality of camera sensors to generate encoded image data;
encoding frequency domain data of radar data from a radar system using an encoder to generate encoded radar data;
fusing the encoded radar data and the encoded image data to generate fused data; and
navigating a vehicle based on the fused data.

12. The method of claim 11, wherein the frequency domain data comprises a range-Doppler cuboid and the encoder comprises a Doppler spectrum encoder.

13. The method of claim 11, further comprising performing a query initialization on a query, the query initialization comprising lifting image features of the encoded image data into a bird's-eye-view (BEV) space to generate lifted image features.

14. The method of claim 13, further comprising performing the query comprising using the encoded radar data to query the lifted image features.

15. The method of claim 13, wherein performing the query initialization, comprises refining uniformly unprojected image features of the query utilizing deformable attention.

16. The method of claim 15, further comprising lifting multiscale image features via a lifting transformer to generate lifted BEV features and wherein fusing the encoded radar data and the encoded image data comprises using the lifted BEV features as input values to a fusion transformer that uses radar BEV features as the query.

17. The method of claim 13, wherein fusing the encoded radar data and the encoded image data comprises combining the lifted image features and the encoded radar data.

18. The method of claim 11, wherein fusing the encoded radar data and the encoded image data is based on learnable BEV queries, radar BEV queries, and learnable positional embedding.

19. The method of claim 11, wherein the Doppler spectrum encoder comprises a ResNet 18 encoder, a Minkwoski Engine, or a Point2Voxel encoder.

20. Non-transitory computer-readable media storing instructions, which, when executed by one or more processors, cause the one or more processors to:
encode image data from a plurality of camera sensors to generate encoded image data;
encode frequency domain data of radar data from a radar system using an encoder to generate encoded radar data;
fuse the encoded radar data and the encoded image data to generate fused data; and
navigate a vehicle based on the fused data.
